(19) United States
(12) Patent Application Publication
(10) Pub. No.: US 2017/0228640 A1
(43) Pub. Date: Aug. 10, 2017

(54) CLOUD INFRASTRUCTURE EVENT ANALYSIS

(71) Applicant: Hewlett Packard Enterprise Development LP, Houston, TX (US)

(72) Inventor: Plamen Valentinov Ivanov, Sofia (BG)

(21) Appl. No.: 15/329,348

(22) PCT Filed: Jul. 29, 2014
(86) PCT No.: PCT/US14/48705

§ 371 Date: Jan. 26, 2017

(51) Int. Cl. G06N 3/08; G06N 3/04

(52) U.S. Cl. CPC G06N 3/08; G06N 3/0436

(57) ABSTRACT

In one example, neuro-fuzzy expert system logic analyzes and assigns significance values to events occurring in a cloud infrastructure. The logic includes event significance logic and a plurality of neuro-fuzzy logic modules. Each of the logic modules includes fuzzy logic to determine a fuzzy value of an effect of a detected event on the cloud infrastructure. The event significance logic includes neuro-fuzzy logic to determine, based on the values of the effects of the detected event determined by the plurality of neuro-fuzzy logic modules, a value indicative of significance of the event to the cloud infrastructure.

### BACKGROUND

As cloud-based services proliferate, the number of events generated in the cloud infrastructure is increasing significantly. To effectively manage cloud-based services, the status of the underlying infrastructure should be monitored and abnormal behavior and deviation from normal or expected service/infrastructure component states should be detected and analyzed. Based on the results of analysis, the appropriate control actions can be applied to prevent or restore services disruptions.

### BRIEF DESCRIPTION OF THE DRAWINGS

For a detailed description of various examples, reference will now be made to the accompanying drawings in which:

FIGS. 1 and 2 show block diagrams of system that applies neuro-fuzzy logic to analyze events in a cloud infrastructure in accordance with principles disclosed herein;

FIG. 3 shows neuro-fuzzy logic arranged to determine the significance of an event in cloud infrastructure in accordance with principles disclosed herein;

FIGS. 4A-4F shows examples of fuzzy values applied in a system for analyzing events in a cloud infrastructure in accordance with principles disclosed herein;

FIG. 5 shows an arrangement of logic layers in neuro-fuzzy logic for analyzing events in a cloud infrastructure in accordance with principles disclosed herein;

FIG. 6 shows a flow diagram for a method for applying neuro-fuzzy logic to analyze events in a cloud infrastructure in accordance with principles disclosed herein; and

FIG. 7 shows a flow diagram for a method for training neuro-fuzzy logic to analyze events in a cloud infrastructure in accordance with principles disclosed herein.

### DETAILED DESCRIPTION

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” The recitation “based on” is intended to mean “based at least in part on.” Therefore, if X is based on Y, X may be based on Y and any number of other factors.

An event can be defined as any detectable or discernible occurrence that has significance for the management of an information technology (IT) infrastructure or the delivery of IT service. Events are evaluated to determine the impact a deviation in operation resulting from the event might cause to services.

Because cloud infrastructure and services are complex, when applied in the cloud context, conventional event analysis methods are subject to a variety of deficiencies. Correlation engines employed in conventional methodologies apply predefined rules and criteria to event analysis. The rules and analysis criteria require continuous tuning, and system experts must be available to provide tuning information and services. Similarly, application of an incorrect level of filtering can result in a flood of insignificant events or misclassification of important events.

The event analysis system disclosed herein includes a neuro-fuzzy expert system that analyzes and categorizes events based on event significance. Neuro-fuzzy expert systems represent fuzzy logic in a neural structure that provides the flexible reasoning of fuzzy logic with the structure and trainability of neural networks. The system disclosed herein analyzes events using previously defined and implemented expert knowledge including fuzzy variables, fuzzy rules, fuzzy inference engines, and fuzzy defuzzification methods. Additionally the system can be trained, thereby eliminating or minimizing the need for constantly available experts that gather and implement expert knowledge, tune and optimize the system.

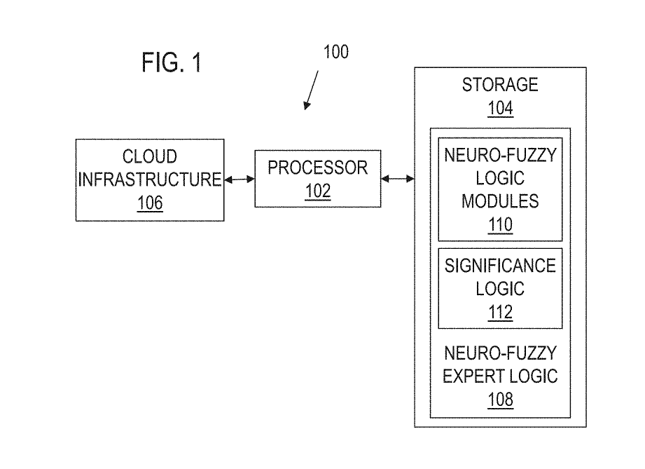

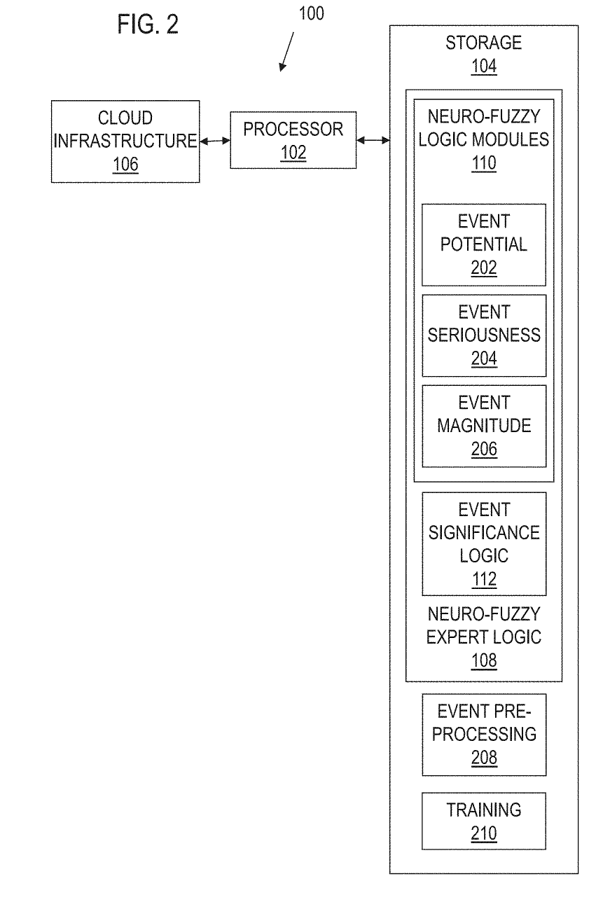

FIGS. 1 and 2 show block diagrams of a system 100 that applies neuro-fuzzy logic to analyze events in a cloud infrastructure in accordance with principles disclosed herein. The system 100 includes a processor 102 coupled to a cloud infrastructure 106 and storage 104. Some implementations of the system 100 may include a plurality of processors 102. The cloud infrastructure 106 may include a plurality of servers, storage systems, and other device interconnected by a communication network, such as a wide area network, the internet, etc. The servers may provide various services to devices and users that access the cloud infrastructure 106. Events occurring in the cloud infrastructure 106 are detected, and the processor 102 is notified. In some implementations the processor 102 may detect events occurring in the cloud infrastructure 106.

The processor 102 may be a general-purpose microprocessor, a digital signal processor, a microcontroller, or other device capable of executing instructions retrieved from a computer-readable storage medium. Processor architectures generally include execution units (e.g., fixed point, floating point, integer, etc.), storage (e.g., registers, memory, etc.), instruction decoding, instruction and data fetching logic, peripherals (e.g., interrupt controllers, timers, direct memory access controllers, etc.), input/output systems (e.g., serial ports, parallel ports, etc.) and various other components and sub-systems.

The storage 104 is communicatively coupled to the processor 102. The storage 104 is a non-transitory computer-readable storage medium suitable for storing instructions that are retrieved and executed by the processor 102 to perform the functions disclosed herein. The storage 104 may include volatile storage such as random access memory, non-volatile storage (e.g., a hard drive, an optical storage device (e.g., CD or DVD), FLASH storage, read-only-memory), or combinations thereof. In some implementations, the processor 102 and the storage 104 may be embodied in a computer, such as a server computer, a rack-mount computer, etc.

Processors execute instructions. Instructions alone are incapable of performing a function. Therefore, in the present disclosure, any reference to a function performed by instructions, or to instructions performing a function is simply a shorthand means for stating that the function is performed by the processor 102 executing the instructions.

The storage 104 includes neuro-fuzzy expert logic 108 and event preprocessing logic 208. The event pre-processing logic 208 includes instructions that are executed by the processor 102 to process events occurring in the cloud infrastructure prior to analysis by the neuro-fuzzy expert logic 108. The neuro-fuzzy expert logic 108 is executable by the processor 102 to analyze and assign significance values to events occurring in the cloud infrastructure 106. The neuro-fuzzy expert logic 108 includes neuro-fuzzy logic modules 110 and event significance logic 112. The neuro-fuzzy logic modules 110 includes event potential logic 202, event seriousness logic 204, and event magnitude logic 206, each of which includes fuzzy logic that is executable by the processor 102 to determine a fuzzy value of an effect of a detected event on the cloud infrastructure 106. The event significance logic 112 includes neuro-fuzzy logic executable by the processor 102 to determine, based on the values of the effects of the detected event determined by the neuro-fuzzy logic modules 110, a value indicative of significance of the event to the cloud infrastructure 106 and services provided thereby.

The event potential logic 202 analyzes event information generated by the event preprocessing logic 208 to determine the potential impact of the detected event on the cloud infrastructure 106. The event seriousness logic 204 analyzes event information generated by the event preprocessing logic 208 to determine the seriousness of the effect of the detected event on the cloud infrastructure 106. The event magnitude logic 206 analyzes event information generated by the event preprocessing logic 208 to determine the magnitude of effect of the event on the cloud infrastructure 106.

The storage 104 also includes training logic 210. The training logic 210 tunes the neuro-fuzzy expert logic 108 to analyze events occurring in the cloud infrastructure 106. A method applied by the training logic 210 to train the neuro-fuzzy expert logic 108 is disclosed herein.

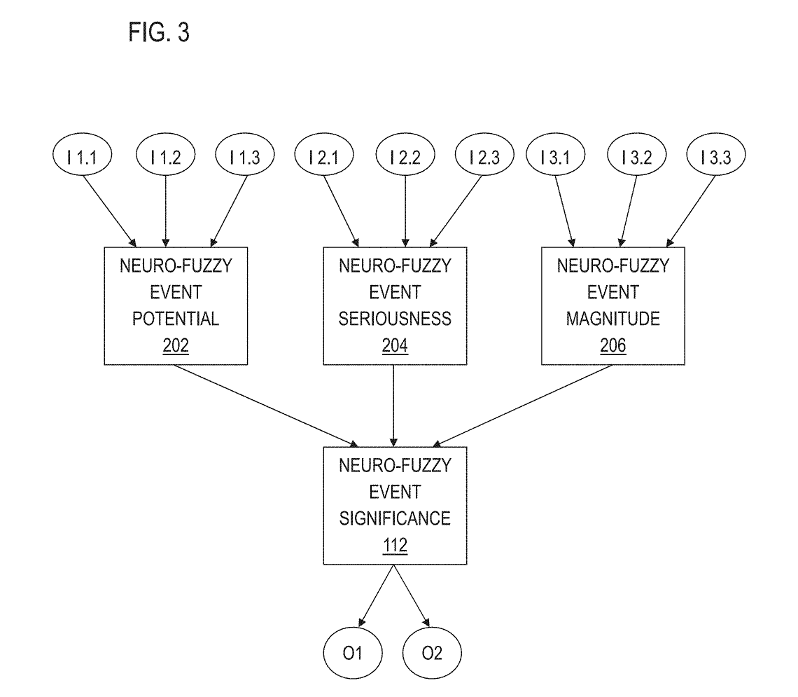

FIG. 3 shows an arrangement of the neuro-fuzzy expert logic 108. The event potential logic 202, event seriousness logic 204, and event magnitude logic 206 receive and apply fuzzy logic processing to input values I1.1 to I3,3 provided by the event preprocessing logic 208. Some implementations of the neuro-fuzzy expert logic 108 may process a different number and/or different types of input values than those described herein. The event significance logic 112 receives fuzzy event potential, event seriousness, and event magnitude values from the event potential logic 202, event seriousness logic 204, and event magnitude logic 206, and applies fuzzy logic to generate event significance output values O1 and O2 based on the event potential, event seriousness, and event magnitude values.

The inputs (I1.1, I1.2, and I1.3) to the event potential logic 202 include information related to the impact of the event on the cloud infrastructure 106. Input value I1.1 may establish the number of events similar to the event currently being analyzed that have occurred in the cloud infrastructure 106, and represent a value of previous similarity impact. Similarity can be determined, for example, based on categorization of the events and/or components impacted. Input value I1.2 may establish the number of components of the cloud infrastructure 106 affected by previously occurring events similar to the event currently being analyzed, and represent a value of previous infrastructure impact. Input value I1.3 may establish the number of services provided by the cloud infrastructure 106 affected by previously occurring events similar to the event currently being analyzed, and represent a value of previous business impact.

The inputs (I2.1, I2.2, and I2.3) to the event seriousness logic 204 include information related to the seriousness of an effect of the event on the cloud infrastructure 106. Input value I1.1 may establish the number of users affected by the current event, and represent a value of customer impact. Input value I2.2 may establish the urgency of the services affected by the event (e.g., based on predetermined service level requirements of the services), and represent a value of service level impact. Input value I2.3 may establish the level of utilization (e.g., not exceeding (low), reaching (medium), exceeding (high) a threshold) of component affected by the event, and represent a value of component impact.

The inputs (I3.1, I3.2, and I3.3) to the event magnitude logic 206 include information related to the magnitude of an effect of the event on the cloud infrastructure 106. Input value I3.1 may establish the number of components of the cloud infrastructure 106 affected by the current event, and represent a value of current infrastructure impact. Input value I3.2 may establish the number of services provided by the cloud infrastructure 106 affected by the event, and represent a value of current business impact. Input value I3.3 may establish the number of similar events currently detected in the cloud infrastructure 106, and represent a value of current similarity impact.

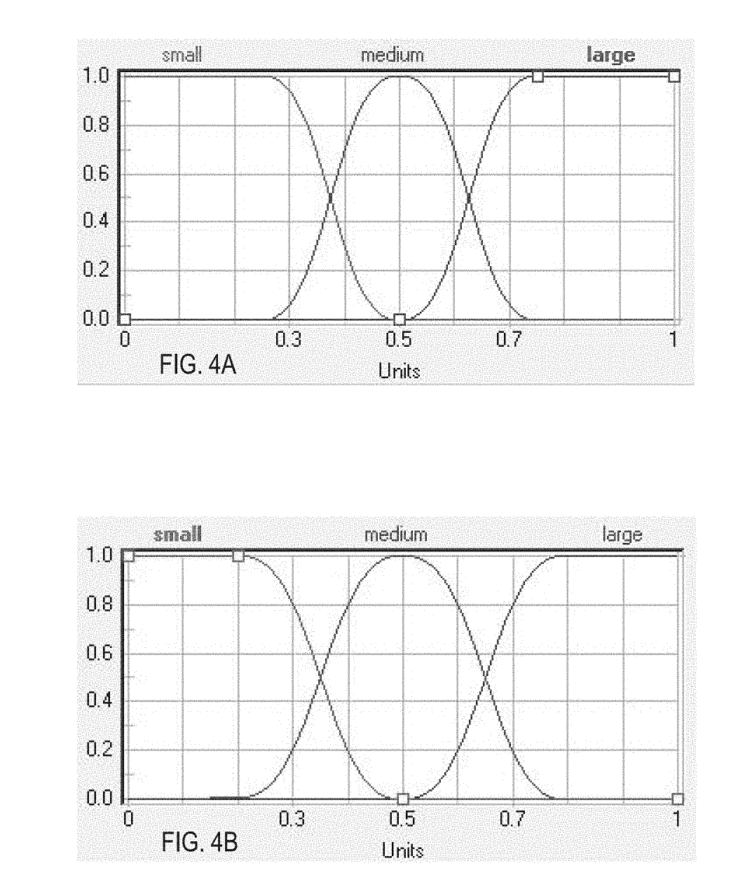

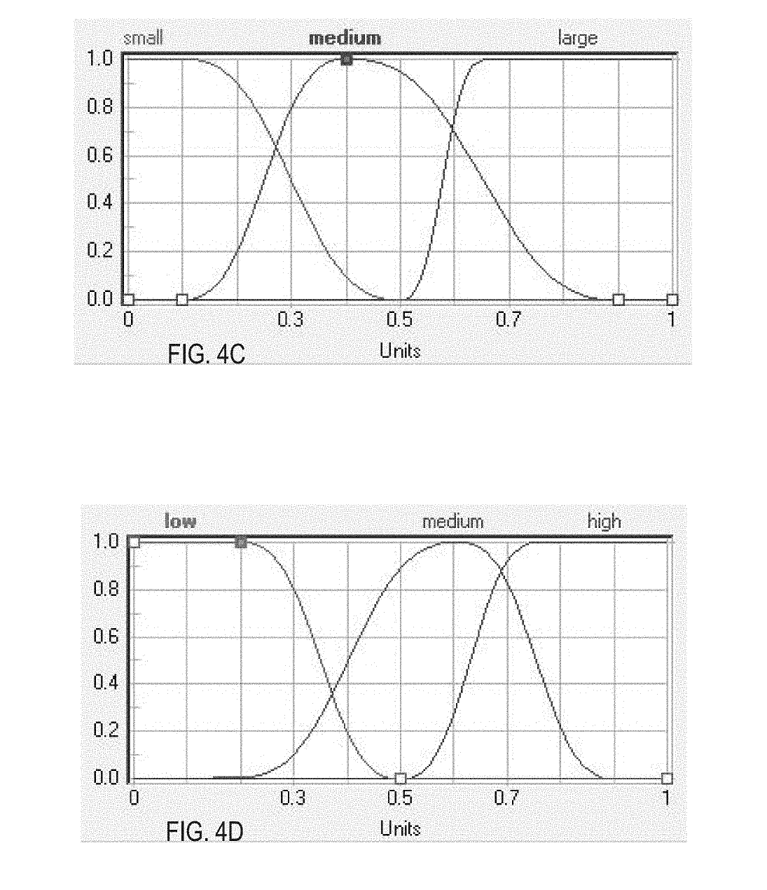

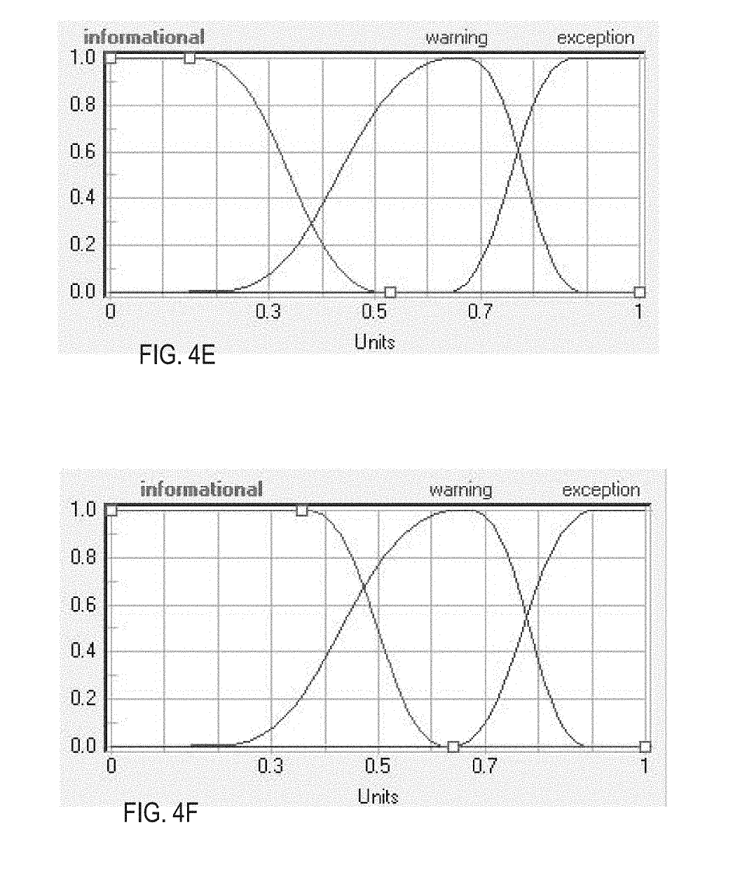

Each of the inputs I1.1-I3.1 are fuzzy input variables whose values (linguistically defined using words such as ‘Low’, ‘Medium’ or ‘High’) are modeled with fuzzy numbers using triangular, sinusoidal or trapezoidal membership functions. Each of these membership functions can be opened for training and tuned automatically by the training logic 210. FIGS. 4A-4D shows examples of fuzzy input values that may be applied in the system 100. In the examples of FIGS. 4A-4D values are expressed as “low,” “medium,” or “high” using various membership functions. In each of FIGS. 4A-4E, the vertical axis represents degree of membership in a fuzzy set (e.g., small, medium, large), and the vertical axis represents the value evaluated for fuzzy set membership. Values evaluated for fuzzy set membership may be normalized as shown in FIGS. 4A-4E, but normalization is not a requirement.

Event analysis result values O1 and O2 may be fuzzy and crisp (defuzzified) values respectively. The result O1 represents fuzzy event significance and may be modeled with fuzzy numbers using triangular, sinusoidal or trapezoidal membership functions. FIGS. 4E and 4F show examples of fuzzy output values that may be provided by the system 100. In the examples of FIGS. 4E-4F, output values are expressed as “informational,” “warning,” or “exception” using various membership functions. Events having informational significance may not require action, but may be stored for future reference. Events having warning significance can be classified as notifications and may need attention, but may not require immediate attention. Events having exception significance may be further investigated and resolved with a higher degree of urgency than events having warning significance. The crisp result value O2 can be used, for example, to sort events within a significance level.

Based on output values O1 and/or O2, a significance of the events can be determined. For example, events can be classified by their significance level according to fuzzy value O1 (e.g., “informational,” “warning,” or “exception”) and, subsequently, the event can be graded using the crisp value O2. Thus, the fuzzy output value O1 can be used to determine a class or category for each event and the crisp value O2 can be used to index the event in that class or category. The crisp value O2 can also be used to further affect the determined class or category, such that an event can be reclassified into a neighboring class or category if the crisp value O2 exceeds or falls below a certain threshold.

The outputs of the significance logic 112 can be passed a management system that manages the events based on the level of significance, provides the analysis results to a human operator and/or automatically manages the events to maintain operation and performance of the cloud infrastructure 106.

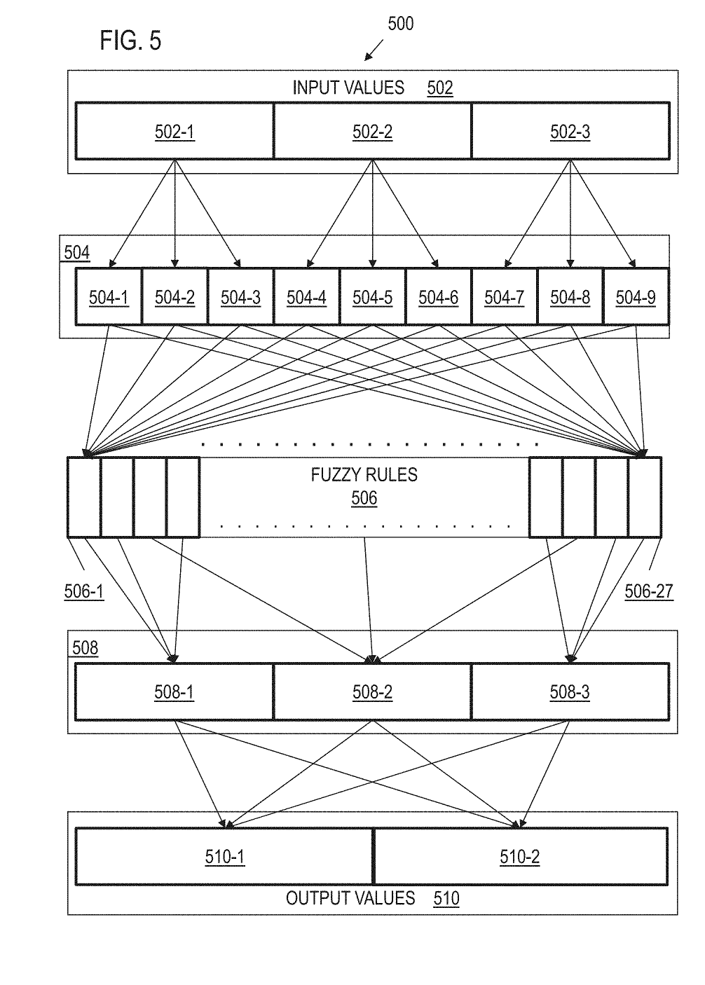

FIG. 5 shows an arrangement of logic layers 500 in neuro-fuzzy logic for analyzing events in a cloud infrastructure in accordance with principles disclosed herein. The logic arrangement of FIG. 5 is applicable to each of the event potential logic 202, event seriousness logic 204, event magnitude logic 206, and event significance logic 112. Accordingly, each of the event potential logic 202, event seriousness logic 204, event magnitude logic 206, and event significance logic 112 may include five neural network layers as shown in FIG. 5. The neural network layers 500 include an input values layer 502, an input terms layer 504, a fuzzy rules layer 506, an output terms layer 508, and an output values layer 510.

The input values layer 502 includes crisp input value nodes 502-1, 502-2, and 502-3 that provide received input values to the input terms layer 504. Each input value nodes 502-1, 502-2, and 502-3 provide an input value to three input term nodes. Input value layer 502-1 provides an input value to input term nodes 504-1, 504-2, and 504-3. Input value layer 502-2 provides an input value to input term nodes 504-4, 504-5, and 504-6. Input value layer 502-3 provides an input value to input term nodes 504-7, 504-8, and 504-9. Some implementations may provide a different number of input value nodes, input term nodes, and/or connections therebetween. The input term layer 504 fuzzifies the crisp input values received from the input values layer 502. For example, nodes 504-1, 504-4, and 504-7 may represent a low value subrange, nodes 504-2, 504-5, and 504-8 may represent, for example, a medium value subrange, and nodes 504-3, 504-6, and 504-7 may represent a high value subrange.

The rules layer 506 includes the fuzzy rules nodes 506-1 to 506-27. In some implementations, the rules layer 506 may include a different number of rules. Each of the rules nodes 506-1 to 506-27 may receive all of the fuzzy term values generated by the input terms layer 504, and process the fuzzy term values in accordance with predetermined neuro-fuzzy expert rule logic to assess the term values. Each of the rules 506 includes a weight value that represents the weight or strength of the rule relative to the other rules 506. Some implementations may include an inference engine that specifies a hierarchy for application of the rules 506-1 to 506-27.

The output terms layer 508 receives results of rule processing by the rules 506 and evaluates the results to produce fuzzy output terms 508-1, 508-2, 508-3. The results of each rule 506 can be combined in different ways, such as using one of a maximum method, a bounded sum method, and a normalized sum method and other suitable methods. Also, the membership degrees of all members of the resulting fuzzy set can be analyzed in order to derive a further approximation of a fuzzy output value. Output terms 508-1, 508-2, and 508-3 may represent, for example, low, medium, and high value subranges respectively. The fuzzy output terms (fuzzy set) generated by the output terms layer 508 are provided to the output values layer 510. The output values layer 510 may generate from the output term values, the fuzzy output value 510-1.

Some implementations of the output values layer 510 may also generate, from the output term values, a crisp (defuzzified) output value 510-2. The crisp value 510-2 can refer to a numerical or real value which can be derived by a defuzzification of the fuzzy set and its membership degrees. In order to determine the crisp value the geometry and shape of the membership functions of the resulting fuzzy set can be analyzed and superimposed to derive a numerical value, for example, from a centroid resulting from the superimposed functions.

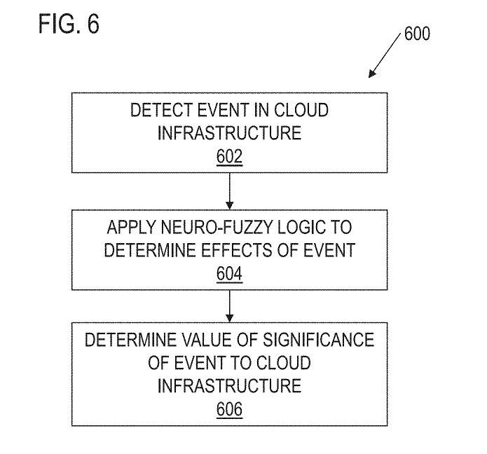

FIG. 6 shows a flow diagram for a method 600 for applying neuro-fuzzy logic to analyze events in a cloud infrastructure in accordance with principles disclosed herein. Though depicted sequentially as a matter of convenience, at least some of the actions shown can be performed in a different order and/or performed in parallel. Additionally, some embodiments may perform only some of the actions shown. In some embodiments, at least some of the operations of the method 600, as well as other operations described herein, can be implemented as instructions stored in the storage 104 and executed by the processor 102.

In block 602, the cloud infrastructure 106 is operating to service requests and provide services to users. The event analysis system comprising the processor 102 is executing the instructions retrieved from the storage 104 to analyze events occurring in the cloud infrastructure 106, and an event is detected in the cloud infrastructure 106. The event preprocessing logic 208 processes the event and generates input values related to the detected event for processing by the neuro-fuzzy expert logic 108.

The event potential logic 202, event seriousness logic 204, and event magnitude logic 206 process the input values using neuro-fuzzy logic to determine values of event potential impact on the cloud infrastructure 106, seriousness of the event to the cloud infrastructure 106, and magnitude of the effect of the event on the cloud infrastructure 106.

In block 604, neuro-fuzzy logic is applied to determine effects of the event on the cloud infrastructure 106. More specifically, the event potential logic 202, event seriousness logic 204, and event magnitude logic 206 provide fuzzy result values for potential impact, seriousness, and magnitude of the event to the event significance logic 112.

In block 606, the event significance logic 112 applies neuro-fuzzy logic to the received input values and determines a fuzzy value representing significance of the event to the cloud infrastructure 106 and operation thereof. A crisp value of event significance may also be generated by the event significance logic 112. The determined values of event significance may be provided to a management system that handles the event in accordance with the determined significance,

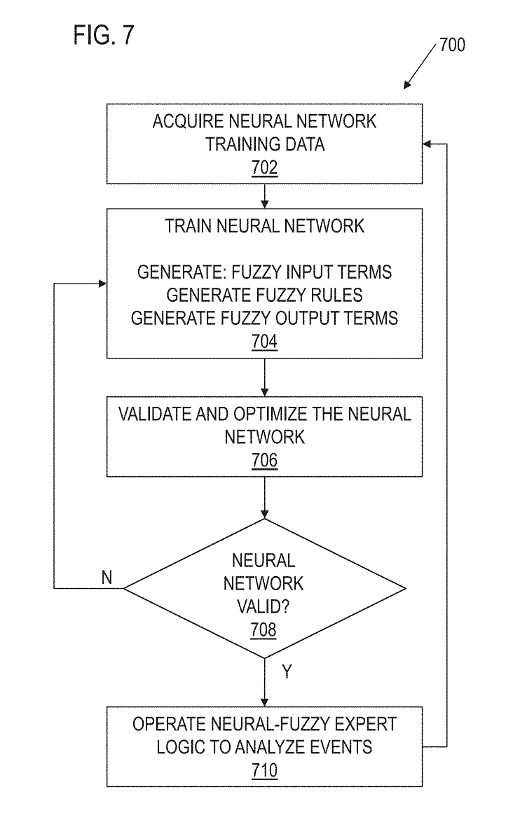

FIG. 7 shows a flow diagram for a method for training neuro-fuzzy logic to analyze events in a cloud infrastructure in accordance with principles disclosed herein. Though depicted sequentially as a matter of convenience, at least some of the actions shown can be performed in a different order and/or performed in parallel. Additionally, some embodiments may perform only some of the actions shown. In some embodiments, at least some of the operations of the method 700, as well as other operations described herein, can be implemented as instructions stored in the storage 104 and executed by the processor 102.

At initiation of the method 700, the event potential logic 202, event seriousness logic 204, event magnitude logic 206, and event significance logic may be untrained. The logic to be trained includes defined fuzzy input variables, membership functions of fuzzy input terms, fuzzy rules, fuzzy rule blocks, fuzzy output variables, membership functions of the fuzzy output values terms, etc, as disclosed herein. In block 702, neural network training data is acquired. The training data includes representative sets of input and out values. The training data can be obtained from daily operations of the system 100 or similar systems, input from human experts, etc. The training data may be modified by a human expert to eliminate irrelevant and insignificant values.

In block 704, the training data is applied to the neuro-fuzzy expert logic 108. The training uses a backpropagation technique that compares the results computed by the neuro-fuzzy expert logic 108 to results provided in the training data, and computes the deviation. Based on the deviation, the neural-fuzzy network weights of the fuzzy rules 506 are modified or membership functions of the fuzzy input terms 504 or fuzzy output terms 508 are adjusted. Weights associated with each of the rules 506 may be changed by starting from the output neurons and going backward through the network to the input neurons. The training executes these operations until the average error is no more than a predefined threshold value. During the training, rules found to be redundant or unnecessary may be deleted.

In block 706, after completion of training, the neuro-fuzzy expert logic 108 is validated by testing the logic 108 with sample data and analyzing the results. If the results are not satisfactory (validation fails in block 708), then training may be repeated until acceptable results are achieved. The neuro-fuzzy expert logic 108 may be optimized by manually changing one or more parameters of the logic.

If the trained system is deemed valid, then, in block 710, the neuro-fuzzy expert logic 108 can be applied to analyze events in the system 100. During operation the processed input and calculated output values can be stored for use as training data.

The training method 700 can be executed on a daily basis or as needed at any specified time interval. By training on a daily or regular basis, the neuro-fuzzy expert logic 108 can be continually and automatically tuned and updated.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a processor;
neuro-fuzzy expert system logic executable by the processor to analyze and assign significance values to events occurring in a cloud infrastructure, the logic comprising:
a plurality of neuro-fuzzy logic modules, each of the logic modules comprising fuzzy logic to determine a fuzzy value of an effect of a detected event on the cloud infrastructure; and
event significance logic comprising neuro-fuzzy logic to determine, based on the values of the effects of the detected event determined by the plurality of neuro-fuzzy network modules, a value indicative of significance of the event to the cloud infrastructure.

2. The system of claim 1, wherein the plurality of neuro-fuzzy logic modules comprise:
event potential determination logic comprising fuzzy logic to determine a value of potential impact of the detected event on the cloud infrastructure;
event seriousness determination logic comprising fuzzy logic to determine a value of seriousness of the effect of the detected event on the cloud infrastructure;
event magnitude determination logic comprising fuzzy logic to determine a value of magnitude of effect of the event on the cloud infrastructure.

3. The system of claim 2, wherein the event potential determination logic is to determine the value of potential impact of the event on the cloud infrastructure based on a number of previously detected events that are similar to the detected event, a number of components previously affected by an event similar to the detected event, and a number of business services previously affected by an event similar to the detected event; wherein the event seriousness determination logic is to determine the value of seriousness of the event based on a number of users of the cloud infrastructure currently affected by the detected event, urgency of services affected by the detected event, and current utilization levels of components affected by the detected event; wherein the event magnitude determination logic is to determine the value of magnitude of effect of the event on the cloud infrastructure based on a number of components affected by the detected event, a number of business services affected by the detected event, and a number of events similar to the detected event detected concurrently with the detected event.

4. The system of claim 1, wherein the plurality of logic modules and the event significance logic each comprises a plurality of layers, the plurality of layers comprising:
an input layer to map discrete values input to the logic module to input fuzzy term values;
a rules layer to apply fuzzy logic rules to the input fuzzy term values; and
an output layer to map output fuzzy term values generated by the rules layer to a fuzzy output value.

5. The system of claim 4, wherein each of the plurality of logic modules and the event significance logic further comprises an inference engine to specify a hierarchy for application of the fuzzy logic rules.

6. The system of claim 4, wherein the output layer is to generate a fuzzy output value and a crisp output value from the output fuzzy term values.

7. The system of claim 4, further comprising training logic to adjust the logic of the input layer, the rules layer, and the output layer of each of the plurality of logic modules and the event significance logic based on comparison of a training data set to outputs of the plurality of logic modules and the event significance logic.

8. A method, comprising:
detecting an event occurring in a cloud infrastructure;
applying neuro-fuzzy logic to determine effects of the event, the effects comprising:
a value of potential impact of the detected event on the cloud infrastructure;
a value of seriousness of the effect of the detected event on the cloud infrastructure;
a value of magnitude of effect of the event on the cloud infrastructure;
determining, via neuro-fuzzy logic, based on the value of potential impact, the value of seriousness, and the value of magnitude, a value indicative of significance of the event to the cloud infrastructure.

9. The method of claim 8, wherein the potential impact of the detected event is determined based on a number of previously detected events that are similar to the detected event, a number of components previously affected by an event similar to the detected event, and a number of business services previously affected by an event similar to the detected event.

10. The method of claim 8, wherein the value of seriousness of the event is based on a number of users of the cloud infrastructure currently affected by the detected event, urgency of services affected by the detected event, and current utilization levels of components affected by the detected event; and wherein the value of magnitude of effect of the event on the cloud infrastructure based on a number of components affected by the detected event, a number of business services affected by the detected event, and a number of events similar to the detected event detected concurrently with the detected event.

11. The method of claim 8, wherein the value of potential impact, the value of seriousness, the value of magnitude, and the value indicative of significance are each determined in a different neuro-fuzzy logic module, and the method further comprises:
processing the detected event in a plurality of layers of each neuro-fuzzy logic module, the processing comprising:
mapping, in an input layer, discrete input values o input fuzzy term values;
applying, a rules layer, fuzzy logic rules to the input fuzzy term values; and
mapping, in an output layer, fuzzy term values generated by the rules layer to a fuzzy output value.

12. The method of claim 11, further comprising specifying, in an inference engine, a hierarchy for application of the fuzzy logic rules.

13. The method of claim 11, further comprising to generating, in the output layer:
a discrete output value of significance from the output fuzzy term values; and
a fuzzy output value of significance from the output fuzzy term values.

14. The method of claim 11, further comprising adjusting logic of the input layer, the rules layer, and the output layer of each neuro-fuzzy logic module and the event significance logic based on comparison of a training data set to outputs of the neuro-fuzzy logic modules.

15. A non-transitory computer-readable medium encoded with instructions that when executed cause a processor to:
provide a neuro-fuzzy expert system to analyze and assign significance values to events occurring in a cloud infrastructure;
determine a fuzzy value of an effect of a detected event on the cloud infrastructure via a plurality of neuro-fuzzy logic modules, each of the logic modules comprising fuzzy logic; and
determine, based on the determined values of the effects of the detected event, a value of significance of the event to the cloud infrastructure; and
manage the event in the cloud infrastructure based on the determined value of significance;
wherein the plurality of neuro-fuzzy logic modules comprise:
event potential determination logic comprising fuzzy logic to determine a value of potential impact of the detected event on the cloud infrastructure;
event seriousness determination logic comprising fuzzy logic to determine a value of seriousness of the effect of the detected event on the cloud infrastructure; and
event magnitude determination logic comprising fuzzy logic to determine a value of magnitude of effect of the event on the cloud infrastructure.
